(19) United States
(12) Patent Application Publication
(10) Pub. No.: US 2021/0248314 A1
(43) Pub. Date: Aug. 12, 2021

(54) EXTRACTED PACKET PARSER FOR EXTERNAL COMMUNICATION PLATFORMS

(71) Applicant: C-TEQ Data Consultants, LLC, Minneapolis, MN (US)

(72) Inventors: Steven J. Hartwig, Edina, MN (US); Benyam A. Daniel, Blaine, MN (US)

(21) Appl. No.: 17/145,577

(22) Filed: Jan. 11, 2021

Related U.S. Application Data
(60) Provisional application No. 62/959,659, filed on Jan. 10, 2020.

(51) Int. Cl. G06F 40/221; G06F 16/93; G06F 40/143

(52) U.S. Cl. CPC G06F 40/221; G06F 40/143; G06F 16/93

(57) ABSTRACT

Methods and systems of extracting and preparing data for use in a document hosting platform are disclosed. The methods and systems are configured to harvest data (e.g., communications or other documents) relevant to a litigation discovery issue that is in a compact object notation format. Through a number of different parsing operations, relevant portions of documents are identified and can be reconstructed for hosting in a document hosting platform.

### CROSS-REFERENCE TO RELATED APPLICATIONS

This application claims priority to U.S. Provisional Application Ser. No. 62/959,659, filed Jan. 10, 2020 and entitled “Extracted Packet Parser for External Communication Platforms,” the disclosure of which is incorporated herein by reference in its entirety.

### BACKGROUND

The ways in which people are communicating for business purposes in the workplace are rapidly evolving. The simple days of typed letters, memos, and phone calls are in the distant past. Even email and text are becoming somewhat outdated compared with business chat rooms and digital bulletin boards that allow for better means of organizing, posting and maintaining an ongoing record of important communications.

During litigation, attorneys are often required to discover relevant evidence that is often explained and revealed by these communication sources, in whatever form those communications are discoverable and capable of being documented. Evolving digital meeting room technologies, conversation threads, and bulletin boards present a challenge as to how to effectively extract complete, accurate and easy-to-read records from disparate, heterogeneous data sources, particularly when some of those data sources reside on public platforms rather than being controlled by a person or enterprise that is subject to litigation hold. Similarly, once this data is accessed and obtained, it may be necessary to pare that data down to a more manageable dataset.

Decades ago, during traditional, paper-based discovery processes, litigation attorneys and associated service providers were faced with the difficulty of finding economical ways to re-create paper files in an efficient and reliable manner, simply because the technology of photocopying was not reliable or cost-efficient. As advancements in copying were made, it became easier to share information on a larger scale.

Today, a similar challenge exists, in that the technology used to harvest and properly preserve salient information from certain “external” communication sources (e.g., communication sources where storage of and access to communications is not necessarily controlled by the communicating entity or its employees) such as Slack, Instagram, SMS text, Twitter, customer relationship management (CRM) tools and the like is currently very limited. In particular, some applications where a third party stores communications but provides only a limited (if any) bulk communication search and retrieval capability, present a prohibitive cost structure, since all communications would need to be manually reviewed within that platform and extracted on an as-needed basis, despite the fact that such platforms are rarely (if ever) designed for such a purpose. In other words, document collection technology is lagging far behind the technology used to create the documents/communications to be collected.

In the particular example of external communication sources mentioned above, in many cases the data that records communications between two or more people is stored and maintained, at least for a period of time, on web resources. Accessing the data is typically done through accounts maintained by individuals of interest, or at the corporate enterprise level. In most cases, however, the data is not stored in a tidy, centralized database, but rather is stored in small packets that are stored and/or passed among various systems, including cloud systems, recipient devices, etc. These smaller, simpler communications that are stored across a dispersed set of data sources consume less space and improves transfer speeds, but makes access of that data significantly more difficult and time-consuming. Nevertheless, users of such external communication sources care more about convenience and performance of the communication platform. If communication can be exchanged nearly instantaneously, users are satisfied and begin to rely more heavily on the newly discovered resource; this happens irrespective of whether subsequent access and review of those communications by those users or others (particularly in the litigation context) is difficult.

### SUMMARY

In general terms, a document parsing tool is provided which is useable to extract and reformat documents for use in a document hosting platform, such as a litigation discovery platform. In example aspects, the document parsing tool is capable of converting files received in a compact object notation format into human-readable formats (e.g., recreating an original appearance of the text of the file for review by a human reviewer).

In a first aspect, a method of extracting and preparing data for use in a document hosting platform is disclosed. The method includes harvesting data from a data source containing documents that are relevant to a litigation discovery issue, the data being harvested in one or more files or folders and having a compact object notation format. The method further includes parsing a user file included in the harvested data to identify one or more users, the one or more users being associated with the documents included in the harvested data, and parsing one or more folders being associated with direct messages exchanged between two or more users to identify a user pair associated with each direct message. The method also includes parsing the one or more files or folders to identify time stamps associated with the documents and convert the time stamps to a user-readable format, and parsing the one or more files or folders to form a list of attachments, each attachment in the list of attachments represented by a filename of a resolved universal resource identifier (URI) included in the files or folders alongside user information and a time stamp. The method also includes extracting identities of communication channel identifiers from the one or more files or folders, and converting document body information to user-readable document body text. The method includes structuring a plurality of documents into human-readable form including the document body text, the identified one or more users, and the time stamps, wherein one or more of the plurality of documents includes an attachment from among the list of attachments, one or more of the plurality of documents comprises a direct message, and at least one of the plurality of documents corresponds to a communication occurring in a communication channel identified by at least one of the communication channel identifiers. Furthermore, the method includes outputting the plurality of documents in human-readable form into a document hosting platform.

A variety of other aspects of the present disclosure are reflected in the disclosure and claims below, and as such, this summary is intended as illustrative rather than limiting.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example environment in which aspects of the present disclosure can be implemented.

FIG. 2 illustrates an example parser tool useable in accordance with the present disclosure.

FIG. 3 illustrates an example computing system with which aspects of the present disclosure can be implemented.

FIG. 4 illustrates an example method of extracting and preparing data for use in a document hosting platform, according to an example embodiment.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

As briefly described above, embodiments of the present invention are directed to extracting and preparing data for use in a document hosting platform. Example methods and systems are configured to harvest data (e.g., communications or other documents) relevant to a litigation discovery issue that is in a compact object notation format. Through a number of different parsing operations, relevant portions of documents are identified and can be reconstructed for hosting in a document hosting platform. Such reformulated documents are readable to users, and useable in litigation contexts, such that attorneys may effectively present evidence to witnesses, courts, and juries in a form that is understandable for the common person.

In accordance with the present disclosure, in example embodiments, a structure object notation format file may be received by a parser tool. Such a structure object notation format file (e.g., a JSON file) may be difficult for an untrained user to view in raw form and recognize various portions of a document described by that file. In particular, it may be difficult for individuals associated with litigation to recognize portions of a document described by such a file, because typically such individuals do not have technical training. Still further, in the context of litigation, those files would need to be transformed to something recognizable to juries as evidence. Also, because structured object notation format files are typically used in the context of large data collections or large data streams, such files are typically received in bulk in the litigation context, because there may be many documents associated with a particular sender or recipient and related to a relevant topic; that large number of documents, even if it could be read by a human, would not allow for efficient review to identify relevant subject matter. Accordingly, the parser tool described herein provides an interface between files that are stored in a compressed, non-human-readable format, identifies relevant document fields, and reconstitutes documents into a human-readable form to be loaded into a document hosting platform, such as a document review software platform useable during litigation.

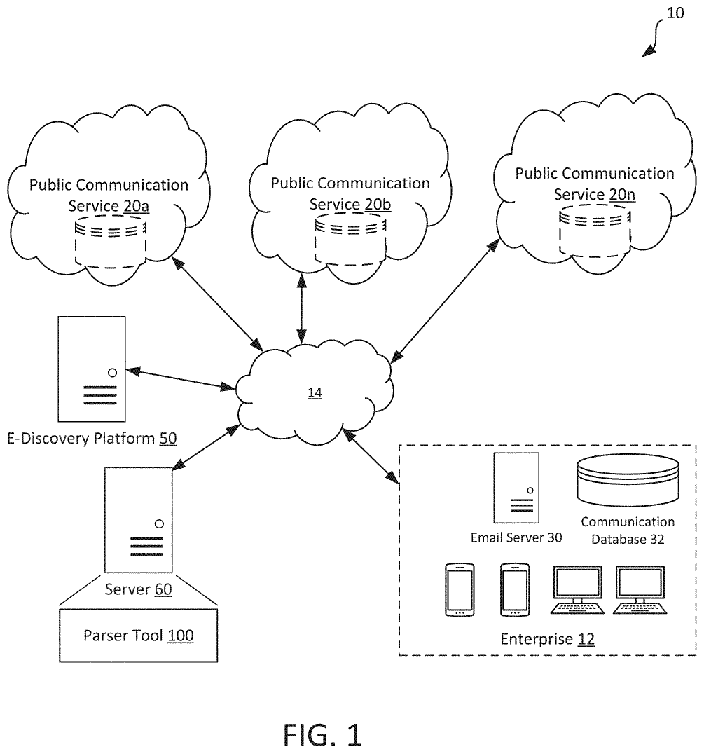

Referring now to FIG. 1, an environment 10 in which aspects of the present disclosure may be implemented is shown. In the example shown, an enterprise 12 may be communicatively connected to the discovery platform 50 via a network, such as the Internet 14. The enterprise 12 may include, for example, and e-mail server 30 as well as a communication database 32. The e-mail server 30 and communication database 32 may store communications among users associated with the enterprise 12, e.g. employees or other individuals who may communicate with employees of the enterprise.

Typically, the context of litigation discovery, an enterprise employee may be able to search the mail server 30 and communication database 32 to identify relevant documents for production in response to discovered requests. However, increasingly, employees and third parties communicate using systems outside of the control of the enterprise 12. For example, a plurality of public communication services 20a-n (referred to collectively or individually as public communication services 20) are shown. In the context of the present disclosure, public communication services 20 may be any of a number of communication services used to pass messages among users, and which store message information. In some cases, such public communication services 20 store message information on third party servers or cloud servers in such a way that the enterprise 12 does not have control over the manner of information storage. Rather, such communication services 20 are generally only accessible by the person using that communication service, and even then, access to his/her own messages and other documents may be limited in terms of format of output or manner of access. Examples of such communication services include Slack, Facebook, Instagram, Twitter, or SMS Text. Other types of communication services may be used as well.

In the example shown, each of the public communication services 20 may provide exported files in response to requests by users of such services. Typically, however, such exported files are in a difficult to read format, such as a structured object notation file format (e.g., JSON). Accordingly, such files may be difficult for the enterprise 12 to identify, but are also difficult, if not impossible to load into discovery platform 50 in native form.

In the example shown, a parser tool 100 may be hosted on a further server system 60. The server system 60 maybe a cloud-based server or may be integrated into the discovery platform 50. In alternative embodiments, the server system 60 may be a server associated with the enterprise 12. In general, the parser tool 100 receives files, such as the structured object notation files exportable from communication services 20, and recreates documents, communications, and communication channel information from such services in a way that are readily understandable to a user.

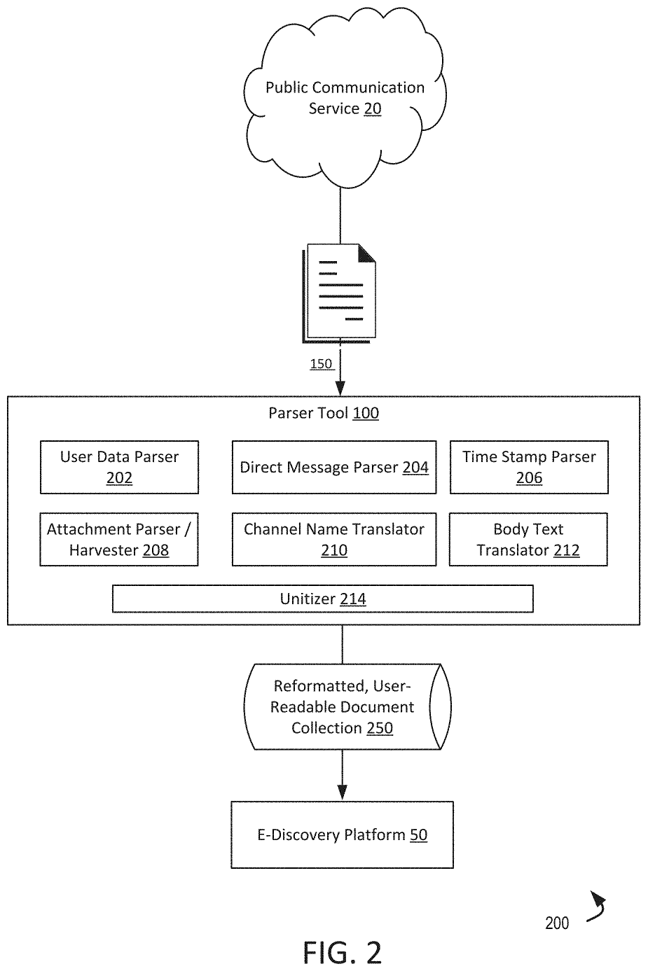

Details regarding the parser tool 100 are provided below in conjunction with FIGS. 2-4. However, generally, operation of the parser tool 100 is illustrated through processing of a JSON file. Created as a simplified and more manageable data packet that transfers communication information, the JSON is smaller than its XML counterpart, but less readable by a user. Decoding the JSON can be set to a smaller group of variables, where other sources of code have many more. JSON is used by many web-based communication applications due to standardization, compactness, and ease of indexing into bulk data storage systems. Such files are written such that they can be interpreted by all the Romance languages. In terms of properly recording communications, JSON files are easily translated across borders and most continents in ways that make its language nearly universal.

To a person (e.g., attorney), however, reading and understanding a JSON in its native form is impractical. Generally, the parser tool 100 ingests raw data packets such as a JSON, and translates those data packets into a recognizable form, such that output documents or other communications are in a format useable to a litigator in order to prosecute claims or defend them. Without a means of decrypting the encoded information packets, data is lost or ignored in cyberspace. For many attorneys that is the fundamental decision they are having to make today. Potentially important evidence is being ignored because the cost of retrieving that evidence is too high and/or the technology to retrieve and properly handle the evidence has not yet been invented. In a litigation setting, the parser tool 100 provides a cost-effective and defensible means of collecting the data and formatting it so that it can be efficiently reviewed.

In example embodiments, the parser tool 100 is used to (1) harvest data in such a way that it can be accounted for; and, (2) alter the presentation of the data from coded language (e.g., JSON or other structured object notation file format) to common language.

The parser tool 100 reads and categorizes the pieces of communication and the associated metadata presented in an information packet. The examples of data parsing and conversion described below in conjunction with FIG. 2 are foundational to the litigator being able to accomplish the goals of establishing the authenticity of the message(s) and to relate that information across messages and/or communication channels. Such parsing and analysis occurs on, for example, the author of the message, date and time of the message, the recipients of the message, members of the group who have access to the message, the message body, and any attachments that may have been included with the message. As explained below, each of these types or portions of each message requires separate handling to be able to reconstruct useable messages in human-readable form.

Referring now to FIG. 2, a detailed view of a process flow using parser tool 100 is shown, in an example embodiment. In the example shown, the parser tool 100 receives files 150 (e.g., in the form of one or more files and/or folders of files) from a communication service 20. The files can be received based on, for example, a bulk request for information associated with a particular user of the communication service, and are received in a structured object notation form.

In subscriptions where bulk exports are not accessible or cost-effective, the parser tool 100 exports the raw data packets (e.g., JSON) and translates them. The parser tool 100 starts at the component part level (individual information packets), which allows for control of the presentation and organization of those parts.

Many of these pieces of JSON data handled by the parser tool 100 are presented as codes—for example, XC94238a65 is a person's name. Similarly, groups, dates, and other pieces of metadata appear as coded information. Look-up tables or cross-references to the codes are often included in the exports that enable translation to common language. Most often, as a mechanism that enables faster transport, rather than embedding attachments in the information packet, documents that are used as attachments are in fact represented as a link to another web resource. The parser tool 100 incorporates an attachment harvester that locates all currently viable attachments, downloads them, and creates a linkage between the attachment and the point in the message string where the document was attached. Having this relationship preserved ensures that all descriptive information about a particular document or communication is preserved, which may provide full context that may be desired from an evidentiary standpoint.

Furthermore, the parser tool 100 allows the end-user the ability to carve out certain key segments of the communication thread, along with any attached documents. Our software provides a workspace where the user can read the evidence and pull out portions that support the story, much like highlighting: the important text is noted but the overall context is not lost.

In example embodiments discussed below, the parser tool 100 obtains source data (e.g., JSON) and converts its physical form to one that can be used by a variety of common document review platforms, used by attorneys and their support staff. The portions of the message that are extracted and transformed include the following:
Message body in text form. Purpose: complete rendition of each message collected.
Metadata (the biographical information re the formation and delivery of the message)
Searchable text—extracted for the purpose of searchability
Attached documents—provide the attachments and their context in the larger conversation.

The above list is an example of parts of documents that are flexibly extracted and displayed, thereby creating flexibility for the end-user in their use of the data while maintaining the integrity of the data vis-à-vis the source, which is also critical in a litigation context.

In the example shown, the parser tool 100 includes a user data parser 202, a direct message parser 204, a time stamp parser 206, an attachment harvester 208, a channel name translator 210, and a body text translator 212. Other operative modules may be included in the parser tool 100 as well, in alternative embodiments. Generally, the parser tool receives files 150 and generates reformatted documents and/or communications readable to a user as noted above. Such reformatted documents and/or communications (referred to herein collectively as “documents”) may be stored in a database 250, and then provided to a document hosting platform such as e-discovery platform 50.

In the example shown, the user data parser 202 parses codes and friendly names from a users.json file that is included in a bulk document download from a communication platform, such as slack. A user ID is obtained and normalized into a form (Last, First), and added to a user lookup table that can be associated with various messages. Generally, the user data parser will loop through a structured object notation file, add entries to the user table for each entry in the file, and convert to user-recognizable name formats. An example code snippet for performing such a parsing action may be as follows:

| WHILE [symbol] FEof (hIn) // Loop through the users.json file | |
|---|---|
| cLine := AllTrim (FGetLine (hIn,256)) | |
| IF cLine = ′″id″:′ | |
| IF cID== ′ ′ | |
| cID := SubStr3 (cLine,8,9) | |
| LOOP | |
| ENDIF | |
| AAdd (aUsers, (cId, cUser)) | // Add entry to the Users table |
| cID := SubStr3 (cLine,8,9) | // 9 digit user ID |
| ELSEIF cLine = ′″name″:′ | // Friendly name |
| cUser := SubStr3 (cLine,10,SLen (cLine −11) | |
| ELSEIF cLine = ′″real_name″:′ | // Also friendly name |

```
    cUser := SubStr3 (cLine,15,SLen (cLine −16)
  ENDIF
END [symbol]
indicates data missing or illegible when filed
```

The end result of such parsing may convert a user entry in a JSON file, e.g., “U1XDGGFPY” to a more readable result, e.g., “Johnson, Bill” for storage in a user table.

The direct message parser 204 is configured to obtain direct message names from folder names that are named with a character code identifying the direct message. For example, a folder name may start with a prefix letter, e.g., “D” and that name may be translated to a user-recognizable name that includes a pair of users associated with a direct message. Accordingly, the direct message parser will (1) see if a folder name corresponds to a direct message code, (2) obtain a user-recognizable name from a direct message lookup list, and then (3) parse the folder name accordingly to convert to a user pair. An example code snippet for performing such a parsing action may be as follows:

IF cChannel=′D′ .and. SLen (cChannel)=9 .and. (n1:=AScan
(aDMUsers, (|a| a[1]==cChannel)))>0
cDMUsers := aDMUsers[n1,2] // Get the DM user name pair

The end result of such parsing may convert a folder name, e.g., “DAQBL5ZT3” to a more readable result, e.g., “JohnsonBill, NelsonJoe” for storage in a list of direct messages.

The time stamp parser 206 obtains timestamps (identified by a “ts” indicator in a JSON file, for example) and convert from epoch time to month/date/year format for use. An example code snippet for performing such a parsing action may be as follows:

ELSEIF cLine = ′″ts″:′ // Timestamp data
cTS := UnixEpoch2Time (INT (Val (SubStr3 (cLine,8,10))), nTZ)

Accordingly, a time stamp originally appearing as “ts:1477589691.000004” may be converted to a more recognizable format, e.g., “ts: 03/15/2019 01:44:30”. Other formats may be utilized as well.

The attachment harvester 208 will generally identify links included in text files, and will harvest the attachments at those links by retrieving items identified by a resolved universal resource identifier (URI). The attachment harvester will also determine an associated message that is related to the obtained attachment, and store the attachment and metadata describing its relationship to a particular document (communication) in a database 250. An example code snippet for performing such a harvesting action may be as follows:

```
ELSEIF cLine = ′″url_private_download″:′ // Add download link to atts.
list
  cAtt += ′ [symbol]     <MESSAGEINFO> ′+StrTran (Slack_GetLineVal
  (cLine), ′\/′,′/′)
  nAtts++
Add the time stamp and user info to the attachments list
IF !cAtt==′ ′
  cAtts += StrTran (cAtt, ′<MESSAGEINFO>′, ′[′+cTs+′ − ′+cUser+′]′)
ENDIF [symbol]
indicates data missing or illegible when filed
```

The channel name translator 210 is configured to obtain channel names and direct message names, for example by reading and translating folder names in an exported dataset, similar to the direct message parser 204 noted above. An example code snippet for performing such a parsing action may be as follows:
aChannels t^{∞} GetDirList(cSrc)//Get a list of the folders in the export data set

This can translate to identify a particular message as being a channel name, which can subsequently be translated to either a channel ID or a name of one or more users.

The body text translator 212 extracts and formats the contents of the body of a document/communication. Generally, the message body is first obtained from a “text:” line within a JSON file, in the continued example from above:

ELSEIF cLine = ′″text″:′
cText := Slack_GetLineVal (cLine)

Additionally, any embedded HTML codes are translated. For example, code to perform such a function may be implemented as follows:

```
nReplace := ALen (aReplace)
FOR nR:=1 UPTO nReplace
  IF Instr (aReplace[nR,1],cOut)
    cOut := StrTran (cOut,aReplace[nR,1],aReplace[nR,2])
  ENDIF
NEXT
```

Still further, embedded escape sequences are detected and translated. For example, code to perform such a function may be implemented as follows:

```
IF Instr (′\′, cOut)
  cOut := StrTran (cOut, ′\/′, ′/′)
  cOut := StrTran (cOut, ′\\′, ′\′)
  cOut := StrTran (cOut, ′\″′, ′ ″ ′)
  cOut := StrTran (cOut, ′\t′, ′ ′)
  cOut := StrTran (cOut, ′\n′, ′\′)
ENDIF
```

Accordingly, a message that originally would appear in this format:
Type: Message
Text: Yes, That Sounds Good
User: U1XDGGFPY
Ts: 1477589787.000006

Would be translated to provide fuller context (e.g., the channel identifier, date, time, user, and message text):
Channel: D086A1AFN
Date: Mar. 15, 2019
02:49:24 PM—Bill Johnson: Yes, That Sounds Good

In accordance with the present disclosure, the parser tool 100 will use one or more backend databases that enable user-determined restructuring techniques, e.g., database 250 which can be used for storage of converted documents and hosting of those documents until exported to a document review platform.

In some example embodiments, a unitizer module 214 may also be utilized with respect to the parsed, reformatted documents to logically arrange those documents into communication strings in a logical sequence for storage in the database 250. This provides flexibility in the definition of documents, allowing the end-user more freedom in how they may elect to cluster and/or segregate communication strings for the purpose of creating logical database records, which can then be coded and notated for future recall. As a reader may highlight important text with markings and sticky notes, the pages are kept in their original position. The unitizer will give the user the advantage of featuring certain key portions of the message content while maintaining the historical relationship of that content to the global population of the messages.

In addition, in some examples, additional features may be included with the parser tool 100 as well. For example, since user-recognizable party names may be generated by the parser tool, one or more automated conflict checking processes may be integrated as well, which identifies opposing parties or other conflict issues where they may occur within communications, which may otherwise not be detected by a human.

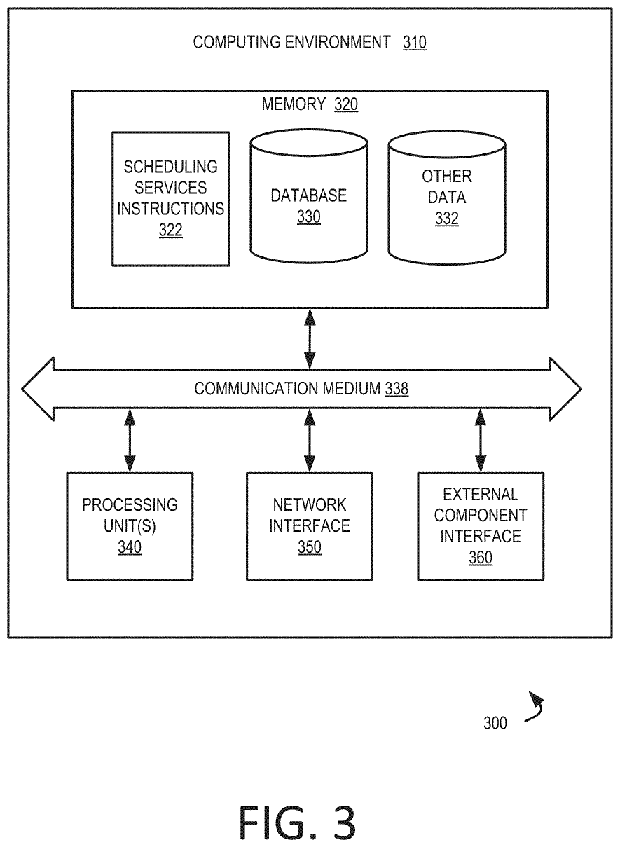

Referring now to FIG. 3, a computing device 300 is shown, with which aspects of the present disclosure can be implemented. The computing device 300 can be used, for example, to implement any of the computing devices of FIGS. 1-2 (e.g., within a cloud or enterprise environment).

In the example of FIG. 3, the computing device 300 includes a memory 302, a processing system 304, a secondary storage device 306, a network interface card 308, a video interface 310, a display unit 312, an external component interface 314, and a communication medium 316. The memory 302 includes one or more computer storage media capable of storing data and/or instructions. In different embodiments, the memory 302 is implemented in different ways. For example, the memory 302 can be implemented using various types of computer storage media, and generally includes at least some tangible media. In some embodiments, the memory 302 is implemented using entirely non-transitory media.

The processing system 304 includes one or more processing units, or programmable circuits. A processing unit is a physical device or article of manufacture comprising one or more integrated circuits that selectively execute software instructions. In various embodiments, the processing system 304 is implemented in various ways. For example, the processing system 304 can be implemented as one or more physical or logical processing cores. In another example, the processing system 304 can include one or more separate microprocessors. In yet another example embodiment, the processing system 304 can include an application-specific integrated circuit (ASIC) that provides specific functionality. In yet another example, the processing system 304 provides specific functionality by using an ASIC and by executing computer-executable instructions.

The secondary storage device 306 includes one or more computer storage media. The secondary storage device 306 stores data and software instructions not directly accessible by the processing system 304. In other words, the processing system 304 performs an I/O operation to retrieve data and/or software instructions from the secondary storage device 306. In various embodiments, the secondary storage device 306 includes various types of computer storage media. For example, the secondary storage device 306 can include one or more magnetic disks, magnetic tape drives, optical discs, solid-state memory devices, and/or other types of tangible computer storage media.

The network interface card 308 enables the computing device 300 to send data to and receive data from a communication network. In different embodiments, the network interface card 308 is implemented in different ways. For example, the network interface card 308 can be implemented as an Ethernet interface, a token-ring network interface, a fiber optic network interface, a wireless network interface (e.g., WiFi, WiMax, etc.), or another type of network interface.

The video interface 310 enables the computing device 300 to output video information to the display unit 312. The display unit 312 can be various types of devices for displaying video information, such as an LCD display panel, a plasma screen display panel, a touch-sensitive display panel, an LED screen, a cathode-ray tube display, or a projector. The video interface 310 can communicate with the display unit 312 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 314 enables the computing device 300 to communicate with external devices. For example, the external component interface 314 can be a USB interface, a FireWire interface, a serial port interface, a parallel port interface, a PS/2 interface, and/or another type of interface that enables the computing device 300 to communicate with external devices. In various embodiments, the external component interface 314 enables the computing device 300 to communicate with various external components, such as external storage devices, input devices, speakers, modems, media player docks, other computing devices, scanners, digital cameras, and fingerprint readers.

The communication medium 316 facilitates communication among the hardware components of the computing device 300. The communications medium 316 facilitates communication among the memory 302, the processing system 304, the secondary storage device 306, the network interface card 308, the video interface 310, and the external component interface 314. The communications medium 316 can be implemented in various ways. For example, the communications medium 316 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 302 stores various types of data and/or software instructions. The memory 302 stores a Basic Input/Output System (BIOS) 318 and an operating system 320. The BIOS 318 includes a set of computer-executable instructions that, when executed by the processing system 304, cause the computing device 300 to boot up. The operating system 320 includes a set of computer-executable instructions that, when executed by the processing system 304, cause the computing device 300 to provide an operating system that coordinates the activities and sharing of resources of the computing device 300. Furthermore, the memory 302 stores application software 322. The application software 322 includes computer-executable instructions, that when executed by the processing system 304, cause the computing device 300 to provide one or more applications, e.g., the parser tool or other tools useable to view documents generated using such a tool. The memory 302 also stores program data 324. The program data 324 is data used by programs that execute on the computing device 300.

Although particular features are discussed herein as included within an electronic computing device 300, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

It is noted that, in some embodiments of the computing device 300 of FIG. 3, the computer-readable instructions are stored on devices that include non-transitory media. In particular embodiments, the computer-readable instructions are stored on entirely non-transitory media.

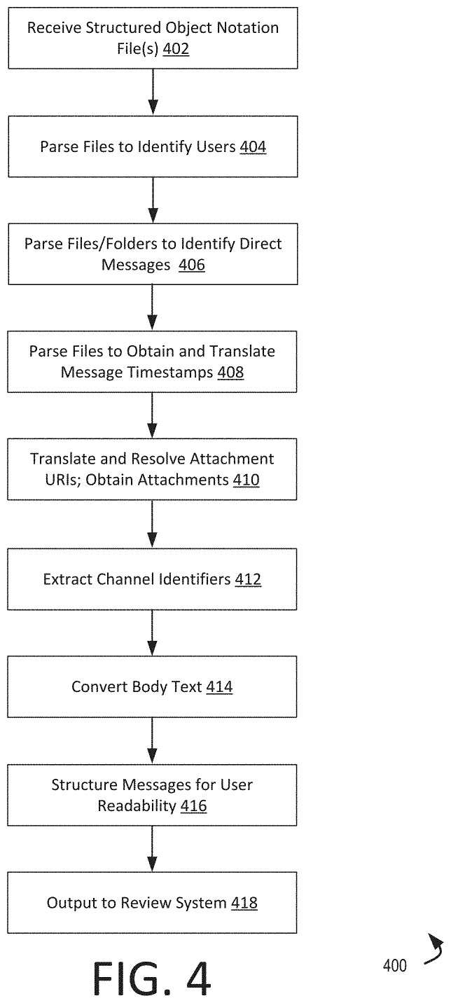

Referring now to FIG. 4, an example method 400 of extracting and preparing data for use in a document hosting platform, according to an example embodiment. The method 400 may be performed, for example, using the parser tool 100 and computing systems described above in conjunction with FIGS. 1-3.

In the embodiment shown, the method 400 includes receiving files (step 402). In examples, the files may be structured object notation files (e.g., JSON); however, the method described herein is readily adaptable to other file types in which documents are described in compacted or translated form not readily readable by a human. The files may be in a predetermined format, for example in a file and folder structure. In alternative embodiments, other methods of harvesting data from a data source containing documents that are relevant to a litigation discovery issue may be utilized.

The method 400 may further include parsing a user file that is included in the harvested data to identify one or more users (step 404). The one or more users may be identified as associated with documents included in the harvest of data. This may be performed, for example using the user identification and parsing process described above in conjunction with FIG. 2.

In the example shown, the method 400 further includes parsing one or more folders that are associated with direct messages exchanged between two or more users to identify a user pair associated with each direct message (step 406). This may be performed, for example using the direct message parsing described above in conjunction with FIG. 2.

The method 400 further includes parsing the harvested files to obtain and translate one or more message time stamps included in the harvested files (step 408). The time stamps are, for example, translated from a computer readable format to a user readable format.

The method 400 also includes parsing the harvested files to form a list of attachments, as well as acquiring those attachments (step 410). This can include, for example, harvesting attachments based on an identification of a universal resource identifier (URI) in translated data that was included in the files or folders harvested from a data source. Harvesting of the attachments may include, for example, downloading the attachments identified by the URI, and storing those attachments with user-recognizable file names in a database associated with the parser tool 100. Additionally, other information may be stored in association with the attachments, such as an identification of a communication document the attachment is associated with, as well as one or more users associated with the communication and attachment. This may be performed, for example, using the attachment harvesting process described above in conjunction with FIG. 2.

In the example shown, the method 400 further includes extracting identities of communication channels from the harvested data (step 412). Extracting identities of communication channels can include parsing names of folders that are associated with communication channels, and translating those folder names to identify user groups, such as user pairs, associated with the communication channel.

Additionally, in the example shown, the method 400 includes converting document body information to user-readable document body text (step 414). This can include, for example, identifying a message text block in a file, converting embedded HTML codes and escape sequences, and translating the text to a human-readable form, as noted above with respect to FIG. 2.

Still further, the method 400 may include structuring the received documents into human-readable form (step 416). The human readable form of the restructured documents can include the document body text, the identified one or more users, and the time stamps. In some cases, one or more of the restructured documents includes an attachment from among a list of attachments. One or more of the plurality of documents may be a direct message as well. In some cases, at least one of the plurality of documents corresponds to a communication occurring in a communication channel identified by at least one of the communication channel identifiers. In some examples, a user may elect to utilize a unitizer module (e.g., module 214 as discussed above) to logically configure documents into ordered groupings that are most easily readable/reviewable (e.g., into logical sequences of messages, email strings, and the like).

In the example shown, the method 400 further includes outputting one or more of the plurality of (now-reconstructed) documents in human-readable form into a document hosting platform. This can include, for example, selecting one or more of the converted documents for upload to a litigation review platform or other software platform. Accordingly, the converted documents may easily be reviewed, and presented during litigation, in a manner that is readily understandable to attorneys, judges, juries, etc.

Referring to FIG. 4 generally, it is noted that the method 400 may be performed in a variety of different orders, based on user preference. For example, different portions of documents may be extracted at different times, and subsets of partially translated documents may be uploaded to a document management or document review system prior to completion of parsing and translation of all documents obtained. Still further, files may be received either in a single collection, or in multiple separate steps, with parsing occurring therebetween.

Referring to FIGS. 1-4 generally it is noted that the parser tool described herein has a number of advantages over existing technologies, particularly with respect to use with third party, public communications services. For example, use of the parser tool 100 provides the ability to decide the appropriate delineation of where documents start and stop. In the classic realm (e.g., Word documents, letters, spreadsheets, power points, etc.), there are certain very objective rules in place that govern the definition of what constitutes a document purely from a structural standpoint. However, in the world of digital, application-based communication (e.g., using third party communication services), document organization within conversation strings is more difficult to delineate. Because of the nature of the data, this question has remained open. Consider a text string between two people that continues across topics for several weeks or months. One portion may discuss personal matters while immediately thereafter, the conversation shifts to a project at work and then to the World Series and so on. Being able to parse out relevant, work-related matters is key to the lawyers, not to mention the judges, magistrates and jurors. This parsing mechanism allows the legal teams to, in effect, segregate portions of the conversation and separate database records or documents that can then be coded, flagged, highlighted, etc. by the legal teams for future reference. The operation of reviewing vast arrays of documents and docketing them by topic or issue is vital to the litigator. Being able to retrieve important documents at a later date is mission-critical. For a litigator, being able to prove the authenticity of the proposed evidence is also foundational to his/her role as a servant to the court.

Costs to export documents from such communication services can be high, and output is not sufficiently reliable for use in a litigation context. Accordingly, the parser tool 100 is configured to parse output from a communication service (e.g., JSON files) such that the data could be parsed into its basic categories of (Message Body, Metadata, Text, and Attachments). This allows the parser to produce a reviewable set of documents in a format for review by a human user quickly and reliably.

By way of contrast, other technologies for handling such files do not break those files down into the components of a message, but rather manage the data as a whole. This makes it difficult to parse sequential conversations; rather than presenting documents and communications on a per-communication basis, documents are broadly grouped by characteristic. Segregating the data for purposes of presenting key facets in the course of depositions or trial is frustrated by the fact the data is housed in SQL and redefining of the document structure is not possible as a result.

Still further, the parser tool is capable of parsing data collected from the source, where data access is generally restricted when using API plug-ins when the accounts are accessed using a restrictive access license. This saves the client time and money and increases their access to potentially important information without requiring purchase of a more expensive license to a data access mechanism. After collection, the parser tool allows for the segregation of important data, while maintaining context. Once the data is ready, the parser tool allows for hosting and review of this data in any hosting tool of their choosing. There is no restriction regarding any specific platform that is hardwired to the source API. This eliminates irrelevant data, and provides freedom to utilize the data on a platform of a user's choosing.

Accordingly, the parser tool described herein provides a solution that offers a flexible, accurate, and reliable output useable in the litigation context. Since many sources of communication data are currently being disregarded as inaccessible or too expensive a proposition, the parser tool described herein overcomes such challenges, allowing parties in litigation an ability to uncover potentially new and important information.

The description and illustration of one or more embodiments provided in this application are not intended to limit or restrict the scope of the invention as claimed in any way. The embodiments, examples, and details provided in this application are considered sufficient to convey possession and enable others to make and use the best mode of the claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. A method of extracting and preparing data for use in a litigation discovery platform, the method comprising:
harvesting data from a data source containing documents that are relevant to a litigation discovery issue, the data being harvested in one or more files or folders and having a compact object notation format;
parsing a user file included in the harvested data to identify one or more users, the one or more users being associated with the documents included in the harvested data;
parsing one or more folders being associated with direct messages exchanged between two or more users to identify a user pair associated with each direct message;
parsing the one or more files or folders to identify time stamps associated with the documents and convert the time stamps to a user-readable format;
parsing the one or more files or folders to form a list of attachments, each attachment in the list of attachments represented by a filename of a resolved universal resource identifier (URI) included in the files or folders alongside user information and a time stamp;
extracting identities of communication channel identifiers from the one or more files or folders;
converting document body information to user-readable document body text;
structuring a plurality of documents into human-readable form including the document body text, the identified one or more users, and the time stamps, wherein one or more of the plurality of documents includes an attachment from among the list of attachments, one or more of the plurality of documents comprises a direct message, and at least one of the plurality of documents corresponds to a communication occurring in a communication channel identified by at least one of the communication channel identifiers; and
outputting the plurality of documents in human-readable form into a document hosting platform.

2. The method of claim 1, wherein the document hosting platform comprises an electronic discovery review software system.

3. The method of claim 1, wherein the data source comprises a data source controlled by an entity that is different from the entity under an obligation to produce documents in accordance with the litigation discovery issue.

4. The method of claim 2, wherein the data source comprises a social media platform.

5. The method of claim 3, wherein the data source comprises one of: Slack, Facebook, Instagram, Twitter or SMS text messages.

6. The method of claim 1, further comprising logically grouping at least some of the plurality of documents via a unitizer to form a document grouping representative of a messaging sequence.
